(19) United States
(12) Patent Application Publication
(10) Pub. No.: US 2008/0273344 A1
(43) Pub. Date: Nov. 6, 2008

(54) DEVICE FOR REPLACING A LIGHT SOURCE IN A MOTOR VEHICLE OPTICAL MODULE

(75) Inventor: Philippe ARLON, Ozoir La Ferriere (FR)

Correspondence Address: MATTHEW R. JENKINS, ESQ., 2310 FAR HILLS BUILDING, DAYTON, OH, 45419, US

(73) Assignee: VALEO VISION, Bobigny Cedex (FR)

(21) Appl. No.: 12/114,202

(22) Filed: May 2, 2008

(30) Foreign Application Priority Data
May 4, 2007 (FR) 07 03 266

(51) Int. Cl. F21V 7/00

(52) U.S. Cl. 362/516

(57) ABSTRACT

A device for replacing a lamp of a light source of a motor vehicle lighting and/or signalling system, comprising a reflecting element, the light source, with a lamp support, secured to the lamp to be replaced, the lamp support providing the holding, in an operating configuration, of the lamp within the reflector, an outer lens for allowing the light rays produced by the light source to pass in the form of a light beam along an optical axis, a housing holding the outer lens and the reflecting element, the lamp support being disposed opposite an opening provided in the housing of the device, and being accessible from the outside of the motor vehicle.

### BACKGROUND OF THE INVENTION

1. Field of the Invention

The object of the present invention is a device for replacing a light source in a motor vehicle optical module. The aim of the invention is essentially to propose a solution for facilitating an operation of changing a light source, in particular a lamp present in a lighting or signalling device.

The field of the invention is, in general terms, that of motor vehicle headlamps.

2. Description of the Related Art

In this field, various types of device are known, intended for illuminating the road or for signalling, among which there are essentially:

tail lights of low intensity and range;

long-range high beams, and supplementary beams of the long-range type, whose area of vision on the road is around 200 meters and must be switched off when passing another vehicle in order not to dazzle its driver; these are beams without cutoff;

fog lights;

passing beams or dipped beams or low beams headlamps, of high intensity and with a range on the road of around 70 meters;

improved headlamps, referred to as dual function, which combine the functions of low beam and high beam by incorporating a removable shade;

signalling devices, for example of the turn indicator type etc.

There exist two main families of optical module, which correspond to two distinct arrangements of the optical modules, and which are able to act in the device according to the invention. Optical module means an optical system comprising at least one light source, for example a halogen lamp or a xenon lamp, disposed in a reflector, and which is preferably self-contained, that is to say which is able to be switched on or off separately from the other optical modules of the lighting device in which it is installed.

The two main families of optical modules are as follows:

The first family is that of so-called elliptical optical modules. In this type of headlamp, a light concentration spot is generated by a light source disposed in a mirror, or reflector. Typically, the light source is disposed at the first focus of an ellipsoid-shaped mirror, the spot forming at the second focus of the mirror. The light concentration spot is then projected onto the road by a convergent lens, for example a lens of the plano-convex type.

The second family is that of so-called parabolic optical modules. In this type of optical module, a light beam is generated by a small light source disposed in a reflector, or mirror. The projection onto the road of the light rays reflected by a suitable reflector makes it possible to obtain directly a light beam complying with the various constraints imposed by standards. This family of optical module includes so-called free-surface, or complex-surface, headlamps, which make it possible to obtain directly a light beam having a desired cutoff line.

As detailed subsequently, the light source to be replaced in the device according to invention can belong either to the first family or to the second family of optical module.

In the devices of the prior art, the light source is fitted within the reflector by being introduced through the rear thereof. An example embodiment of a lighting device 106 of the prior art, illustrating such a fitting, is given in FIG. 1.

FIG. 1 depicts in section, schematically, a reflector 100 to which a light source 200 is fixed. The light source 200 comprises essentially a lamp 201 fixed to a support 202. The reflector 100 consists of an external face 101 and an internal face 102. The internal face 102 is also called the optical surface of the reflector: it is that which is responsible for reflecting the light rays emitted by the light source 200 when the latter is fixed to the reflector 100 and the lamp 201 radiates.

The reflector 100 comprises a circular opening 103 provided approximately at its top.

The operation of simplified fixing of the light source 200 to the reflector 100 can be broken down for example into two distinct movements: a first movement, referred to as introduction, consists of a translation along an axis and in a direction 107, corresponding to the mounting axis 108 of the light source 200, towards the reflector 100 so that lamp 201 is introduced into the circular opening 103 of the reflector 100 by bringing into contact an abutment surface on the external face 101 of the reflector 100 and an abutment surface on the support 202 of the lamp 201. The lamp 201 is thus brought opposite an outer lens 110, through which the light rays issuing from the light source 200 will be emitted either directly or after reflection on the reflector 100. Introduction through the rear of the reflector 100 is spoken of, the lamp 201 being brought into position in the reflector 100 through the circular opening 103 in the reflector 100. One advantage of such an introduction through the rear is that the lamp 201 does not risk coming into contact with the internal face 102 of the reflector 100 and thus does not risk damaging the internal face 102.

In general terms, the direction 107 of introduction corresponds to the mounting axis 108 of the lamp 201. The mounting axis 108 is defined as the direction in which an operation of mounting the lamp 201 in question takes place. A mounting axis 108 has a mounting orientation corresponding to the direction of movement followed on the mounting axis 108 when the lamp 201 is removed from the reflector 100. The dismantling orientation has a direction opposite to the direction of the mounting operation.

Once the introduction movement is finished, it is then possible to proceed with the second movement, which consists of effecting the locking of the light source 200 on the reflector 100. The locking step consists of a rotation movement of the light source 200 with respect to the reflector 100. In other example embodiments of the prior art, a single movement, for example translation, is sufficient to place the lamp within the reflector.

If the structures of the supports and reflectors vary from one lighting device to another, it has been chosen in all the optical modules of the prior art, in particular in order to protect the reflective surface of the reflector in question, to position the light sources within the reflectors by introducing them through the rear of the reflector, as in the example that has just been described. The operation of withdrawal, or removal, of the light sources therefore also takes place through the rear of the reflector, at the rear of the headlamp.

A problem is therefore posed for the replacement of the light sources of the optical modules of the prior art: this is because, as explained, these must necessarily be removed through the rear of the optical module, being removed through the bottom of the reflectors in which they are disposed. However, the rear of the optical modules is not directly accessible from the outside of the vehicle on which it is installed since, in the embodiments of the prior art, it is situated opposite to the outer lens of the headlamp in question, in the area of the optical module furthest away from the part visible from the outside of the vehicle.

Consequently, the operating of replacing the lamps is particularly tedious, and rarely accessible to the majority of motor vehicle users. This is because the existing solutions are essentially of two types: either it is necessary to totally remove the lighting device for which it is wished to change the lamp, in order to be able to access it from the rear; or it is necessary to move it, for example by means of specific rails, in order to be able to have available sufficient space for sliding the hand and accessing the lamp to be replaced, in a fairly uncomfortable fashion.

Moreover, it should be noted that it is impossible, for regulatory reasons but also for physical reasons—the outer lens being bonded to the housing of the lighting device in question—to remove the outer lens in order to more simply access the lamp to be replaced. Even if the outer lens could be removed, the fact that the lamp must be removed with its support through the rear of the reflector would still make the operation of replacing the lamp complicated.

There is, therefore, a need to over come or more of the problems of the prior art.

### SUMMARY OF THE INVENTION

The object of the present invention is a device for replacing a light source in a motor vehicle optical module. The aim of the invention is essentially to propose a solution for facilitating an operation of changing a light source, in particular a lamp present in a lighting or signalling device.

The object of the invention proposes a solution to the problems that have just been disclosed. In the invention, a device for replacing an optical module lamp in a simple fashion, without having to move—and even more so without having to remove—the optical module in question, is proposed. To this end, in the invention, it is proposed in particular to modify the arrangement of various elements within an optical module, in particular by making the light source comprising the lamp to be replaced directly accessible from the outside of the vehicle; advantageously, the light source is then oriented in a direction roughly opposite to that of the optical axis of the optical module in question. A first direction and a second direction, for example of propagation of light signals, are said to be roughly opposed if, considering the vectors that they represent, the scalar product of these vectors is negative.

The support of the light source, holding the lamp to be replaced, is therefore the first element of the light source that may be accessible from the outside of the vehicle. Thus, in the invention, provision is made for achieving access to the support of the light source, directly from the outside of the vehicle; the light source comprising the lamp to be replaced can thus be directly withdrawn from the optical module to which it belongs, without having to move the whole of the optical module. Advantageously, the reflector of the optical module has a structure adapted for reflecting the light rays issuing from the light source and transmitting them, through the outer lens associated with the optical module, in their required illumination direction.

The invention therefore concerns essentially a device for replacing a lamp of a light source of a motor vehicle lighting and/or signalling system, comprising in particular:

a reflecting element;

the light source, with a lamp support, secured to the lamp to be replaced, the lamp support providing the holding, in an operating configuration, of the lamp within the reflector;

an outer lens for allowing the light rays produced by the light source to pass in the form of a light beam along an optical axis;

a housing holding the outer lens and the reflecting element;

such that the lamp support is disposed opposite an opening provided in the housing of the device, and is accessible from the outside of the motor vehicle (considering the lighting and/or signalling system in the mounted position in the vehicle).

Preferably, the lamp mounting axis is situated below (or above) the optical axis of the light beam emitted by the device through its outer lens (still considering the device in its mounted position in the vehicle).

Apart from the main characteristics that have just been mentioned in the preceding paragraph, the device according to the invention can have one or more additional characteristics among the following:

the lamp has a mounting axis oriented in a direction roughly opposite to that of the optical axis of the beam (“roughly” opposite means the fact that the axes are parallel to each other, or oblique with respect to each other, forming between them a preferably obtuse angle, in particular between 90° and 180°, as exemplified below);

the opening in the housing of the device, provided opposite the lamp support, is produced under a plane defining an edge (for example bottom, top, lateral) of the outer lens;

the opening in the housing of the device, provided opposite the lamp support, is closed by a removable cap providing the impermeability of the housing;

the opening in the housing is accessible from the outside of the vehicle at a part of the vehicle situated in an extension (for example bottom, top, side) of the outer lens;

the opening in the housing is accessible from the outside of the vehicle at an inspection flap;

the opening in the housing is accessible from the outside of the vehicle at an air inlet;

the reflecting element has a reflection surface able by itself to modify the orientation of the light rays produced by the light source so that they are emitted through the outer lens;

the reflecting element cooperates with a complementary optical element so as to modify the orientation of the light rays produced by the light source so that they are emitted through the outer lens;

the complementary optical element is a mirror, or a transparent bar;

the lighting system comprises an inner lens (and/or any other optical means of the dioptric element type or the like);

the mounting axis of the light source has an inclination with respect to a horizontal plane, the angle of inclination lying, in absolute value, between 0 and 900, in particular between 0 and 45°;
the lighting system comprises at least one element of the mask type, masking the lamp and/or part of the outer lens foot from outside the vehicle (“outer lens foot” means the peripheral area of the closure outer lens of the device, which is the area of fixing the outer lens to the housing);

the lighting system fulfils a function of the low beam type, or a function of the high beam type, or a function of the low beam type and a function of the high beam type;

the lamp is of the halogen type or of the xenon type, or of the incandescent lamp type or of the light emitting diode type.

The various additional characteristics of the device according to the invention, in so far as they are not mutually exclusive, are combined according to all possibilities of association in order to end up with various example embodiments of the invention.

The present invention also relates to a motor vehicle equipped with the device according to the invention, with its main characteristics, and possibly one or more supplementary characteristics that have just been mentioned.

The invention and its various applications will be understood better from a reading of the following description and an examination of the figures that accompany it.

These and other objects and advantages of the invention will be apparent from the following description, the accompanying drawings and the appended claims.

### BRIEF DESCRIPTION OF THE ACCOMPANYING DRAWINGS

These are presented only by way of indication and are in no way limitative of the invention. The figures show:

FIG. 1, already described, is an example embodiment of an optical module of the prior art, illustrating an introduction of a light source through the rear of the reflector;

FIG. 2 is a first example embodiment of the device according to the invention;

FIG. 3 is a second example embodiment of the device according to the invention;

FIG. 4 is a third example embodiment of the device according to the invention;

FIG. 5 is a particular example of a reflector able to be used in the device according to the invention; and

FIG. 6 is an example reflector of FIG. 5 disposed in a device according to the invention.

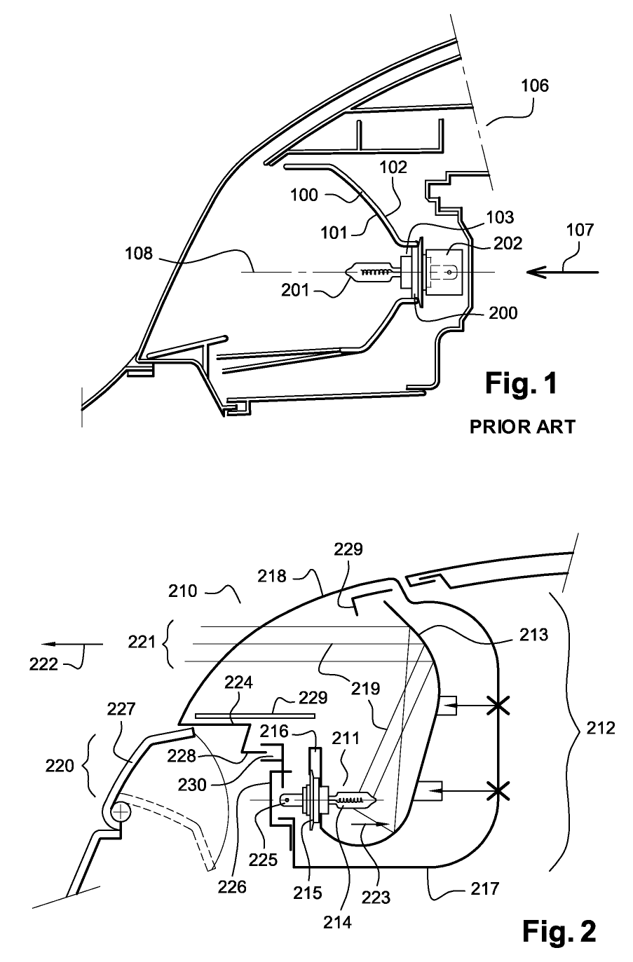

### DETAILED DESCRIPTION OF THE PREFERRED EMBODIMENTS

The various elements appearing in several figures will, unless specified otherwise, have kept the same reference. The concepts of direction and position of the “top”, “bottom”, “vertical” etc type are mentioned under conventional conditions of arrangement of the optical lighting and/or signalling device involved in the device according to the invention, that is to say in a roughly horizontal position, and an optical axis contained in a substantially horizontal plane.

FIG. 2 shows a first example 210 according to the invention of a device for replacing a light source 211, or a lamp 214 of the light source. The device 210 comprises essentially a lighting system 212, here a lighting device of the low beam type, and a facilitated access 220 to the light source 211 to be replaced.

The lighting system 212 comprises in particular the light source 211, which is held on a particular part of a reflector 213, designated as the lamp holder 215. The light source 211 is itself made of a lamp 214 held in a lamp holder 215. The reflector/light source assembly is disposed in a housing 217, fixed to the vehicle and providing in particular the fixing of the reflector 213, which is supplemented, on its front part, by an outer lens 218. The outer lens 218 terminates, in particular at a bottom edge 224, roughly horizontal, in an outer lens foot 228, which is inserted in a bonding groove 230 in the housing 217.

The light source 211 emits a plurality of light rays 219 that contribute to producing a global light beam 221 emitted through the outer lens 218 and having an optical axis 222, corresponding to an axis and direction of maximum intensity. In the example shown, the reflector 213 has a reflection surface able by itself alone to modify the orientation of the plurality of light rays 219 produced by the light source 211 so that they are emitted through the outer lens 218.

The light source 211 is oriented in a direction 223, corresponding to its mounting direction, roughly opposite to the direction of the optical axis 222. The light source 211 here has a mounting axis, which has an angle with the optical axis 222 of between 90 degrees and 180 degrees. In the example depicted, this angle is close to 180 degrees. In other words, the mounting axis has, considering the direction 223, an angle of inclination with a respect to the horizontal of between, in absolute value, 0 and 90 degrees; in the majority of example embodiments, this angle is more precisely between 0 and 45 degrees.

As a general meaning in this invention, roughly opposite direction means the fact that the half line extending the filament in the direction opposite to that of the support of the light source, or, in the case of a discharge lamp, comprising the axis joining the two electrodes and extending in the direction opposite to that of the support of the light source, or, in the case of an LED, corresponding to the mean direction of emission of the light from the LED, would never pass through a plane defined by the entry face of the projection lens. For example, in the case of a lambertian LED the mean direction of emission of light from the LED is the half-perpendicular to the plane of the semiconductor and which extends in the direction opposite to the illuminating surface of the semiconductor.

Thus, seen from the outside of the motor vehicle on which the device 210 is installed, it is the lamp holder 215 that constitutes the first accessible element of the lighting system 212. To make the light source 211 effectively accessible, provision is made, in this example embodiment, to place it below the outer lens 218. Thus the light source 211 is disposed below a plane defining the bottom edge 224, roughly horizontal, of the outer lens 218. In addition, provision is made for producing in the housing 217 an opening 225 placed opposite the lamp 214. The opening 225 is closed, for sealing reasons, by a cap 226, which may be screwed, clipped or held by any other means on the opening 225.

To access the opening 225, provision is made, in this example embodiment, to provide an inspection flap 220, constituting the previously mentioned access, opposite the opening 225, closed by a cap 227. The operation of replacing the light source 211 is then particularly easy: it suffices for the operator to move or withdraw the removable cap 227, to slide his hand into the inspection flap 220, and to remove the cap 226. He then directly accesses the light source 211, which he can remove, simply by exerting a traction force on the lamp 214, and replace easily.

In other examples, the inspection flap 220 can simply correspond to an air inlet present on the face of the vehicle equipped with a device according to the invention.

In certain example embodiments, provision is made, in the lighting system 212, for the arrangement of masks 229 intended to conceal, for aesthetic reasons, the light source 211 from the outside of the vehicle, in particular through the outer lens 218. The masks 229 sometimes also serve to mask the lamp foot 228.

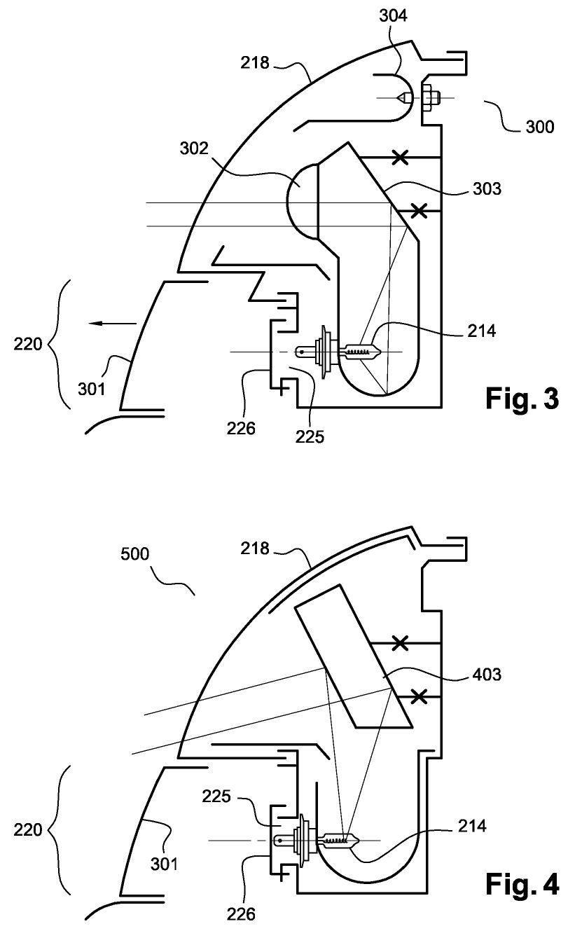

The example embodiment or device 300 shown in FIG. 3 differs from that of FIG. 2 essentially through the fact that the optical system involved is different. In FIG. 3, the optical system present in the device according to the invention is of the elliptical type, with the presence in particular of an inner lens 302, for emitting the global light beam 221 through the outer lens 218, and an optical element of the bender type 303, or mirror, to divert at least some of the light rays 219 towards the inner lens 302. In addition, the device 300 comprises a supplementary module 304 of the turn indicator type. This example illustrates the fact that the device according to the invention can be produced for very varied types of lighting device.

In another example embodiment 500 according to the invention, depicted in FIG. 4, the bender 303 is replaced by an optical element of the transparent bar type 403, fulfilling a similar function.

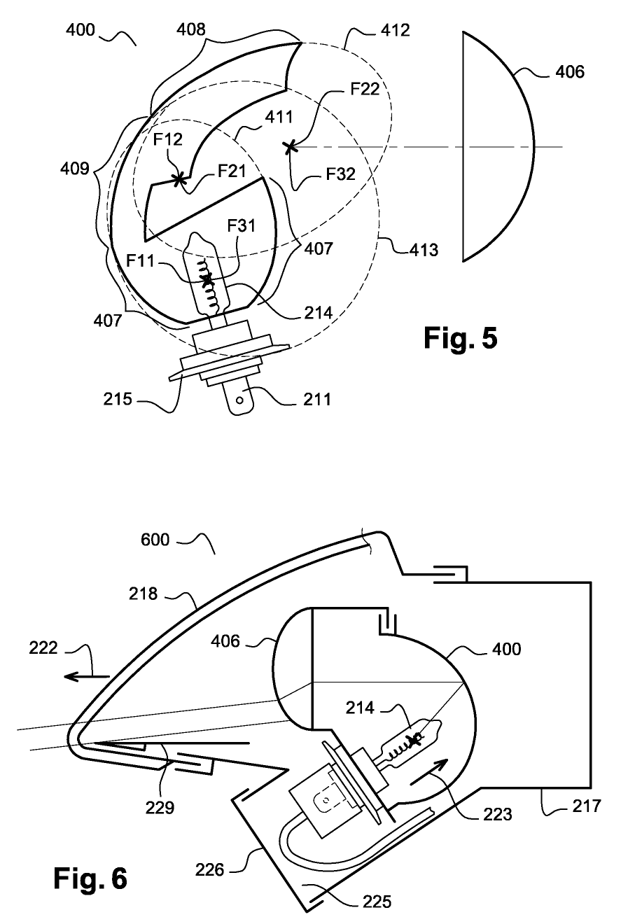

FIG. 5 shows an example embodiment, in plan view, of a reflector 400 able to be used with an inner lens 406 in an example device according to the invention. The example in FIG. 4 shows a possible embodiment for, starting from a light source that is not aligned with the optical axis of the lighting device in which it is inserted, emitting a light beam in a roughly horizontal direction.

The reflecting surface of the reflector, corresponding to its internal face, will be defined in particular with reference to surfaces defined using the term ellipsoid. In general terms, an ellipsoid, designating here an ellipsoid of revolution, is a volume generated by the rotation of an ellipse about one of its axes. Thus any planar section of an ellipsoid is an ellipse. In the present document, reference is made to the terms “ellipsoid shapes” in order to designate a particular shape, the closest known generic mathematical representation of which is the ellipsoid. As is known, an ellipsoid has three main ellipses, corresponding to the intersections of the principal planes of the ellipsoid with the ellipsoid. Main focus of an ellipsoid means each of the foci of the principal ellipses of the ellipsoid. Two distinct ellipsoids having a principal focus in common are said to be conjugate. The expression “principal focus of an ellipsoid shape” designates a point situated in the immediate vicinity of a principal focus of the ellipsoid most approaching the ellipsoid shape in question.

In the example depicted, the reflector 400 is formed by the joining of three distinguishable parts:

a first part 407 consists of a portion of a first ellipsoid shape 411, designated as the first portion, characterized by a first principal focus F11 and by a second principal focus F12; the filament of the lamp is approximately centered on the first principal focus F11;

a second part 408 consists of a portion of a second ellipsoid shape 412, designated as the second portion, characterized by a first principal focus F21 and by a second principal focus F22; according to the invention, the first ellipsoid shape 411 and the second ellipsoid shape 412 are conjugate, that is to say the first principal focus F21 of the second ellipsoid shape 412 and the second principal focus F12 of the first ellipsoid shape 411 are merged;

a third part 409 consists of a portion of a third ellipsoid shape 413, designated as the third portion, characterized by a first principal focus F31 and by a second principal focus F32; the third part 409 provides the continuity, between the first part 407 and the second part 408 previously mentioned, of the reflecting surface of the reflector 400. In the example shown, the third ellipsoid shape 413 is conjugate with the first ellipsoid shape 411 and the second ellipsoid shape 412: on the one hand the first focus F11 of the first ellipsoid shape 411 and the first principal focus F31 of the third ellipsoid shape 413 are merged; on the other hand the second principal focus F22 of the second ellipsoid shape 412 and the second principal focus F32 of the third ellipsoid shape 413 are merged.

FIG. 6 shows an example of a device 600 according to the invention in which the reflector 400, associated with the inner lens 406, is put in place. The light source 211 is, as also seen in this example, easily accessible from the outside of the vehicle by simple removal of the cap 226, the inclination between the mounting axis of the light source 211 and the optical axis of the headlamp being in this example around 45 degrees.

While the forms of apparatus herein described constitutes a preferred embodiment of this invention, it is to be understood that the invention is not limited to this precise form of apparatus, and that changes may be made therein without departing from the scope of the invention which is defined in the appended claims.

What is claimed is:

1. A device for replacing a lamp of a light source of a motor vehicle lighting and/or signalling system, comprising in particular:
a reflecting element;
said light source, with a lamp support, secured to said lamp to be replaced, said lamp support providing the holding, in an operating configuration, of lamp within said reflecting element;
an outer lens for allowing light rays produced by said light source to pass in the form of a light beam along an optical axis;
a housing holding said outer lens and said reflecting element;
wherein said lamp support is disposed opposite an opening provided in said housing of said device, and is accessible from outside of a motor vehicle.

2. The device according to claim 1, wherein said lamp has a mounting axis oriented in a direction roughly opposite to that of said optical axis of said light beam.

3. The device according to claim 2, wherein said mounting axis of said lamp is situated below or above said optical axis of said light beam emitted by said device through said outer lens of said device.

4. The device according to claim 1, wherein said opening in said housing of said device, provided opposite said lamp support, is produced under a plane defining an edge of said outer lens.

5. The device according to claim 1, wherein said opening in said housing of said device, provided opposite said lamp support, is closed by a removable cap providing a seal on said housing.

6. The device according to claim 1, wherein said opening in said housing is accessible from outside of said motor vehicle at a part of said motor vehicle situated in line with said outer lens.

7. The device according to claim 1, wherein said opening in said housing is accessible from outside of said motor vehicle at an inspection flap.

8. The device according to claim 1, wherein said opening in said housing is accessible from outside of said motor vehicle at an air inlet.

9. The device according to claim 1, wherein said reflecting element has a reflection surface able by itself to modify orientation of said light rays produced by said light source so that said light rays are emitted through said outer lens.

10. The device according to claim 1, wherein said reflecting element cooperates with a complementary optical element so as to modify orientation of said light rays produced by said light source so that said light rays are emitted through said outer lens.

11. The device according to claim 10, wherein said complementary optical element is a mirror or a transparent bar.

12. The device according to claim 1, wherein said lighting system comprises an inner lens.

13. The device according to claim 1, wherein said mounting axis of said light source has an angle of inclination with respect to a horizontal plane, said angle of inclination being, in absolute value, between 0 and 90 degrees, in particular between 0 and 45 degrees.

14. The device according to claim 1, wherein said device comprises an access to a support of said light source, directly from outside of said motor vehicle; so that said light source can be directly withdrawn from an optical module to which it belongs, without having to move the whole of said optical module.

15. The device according to claim 1, wherein said lamp is of a halogen type or of a xenon type, or of an incandescent lamp type or of a light emitting diode type.
